(19) United States
(12) Patent Application Publication
(10) Pub. No.: US 2013/0040121 A1
(43) Pub. Date: Feb. 14, 2013

(54) Thermally Expandable Crimped Hollow Fibers and Methods of Using Same

(71) Applicant: KAPIL M. SINGH, West Chester, OH (US)

(72) Inventor: KAPIL M. SINGH, West Chester, OH (US)

(73) Assignee: INTERNATIONAL PAPER COMPANY, Memphis, TN (US)

(21) Appl. No.: 13/554,166

(22) Filed: Jul. 20, 2012

Related U.S. Application Data
(60) Provisional application No. 61/521,530, filed on Aug. 9, 2011.

(51) Int. Cl. D21H 21/50; D21H 15/04; B32B 29/06; D01D 5/22; D02G 1/00

(52) U.S. Cl. 428/219; 264/168; 428/370; 162/146

(57) ABSTRACT

Thermally expandable crimped hollow fibers having expandable regions interconnected with crimped portions are provided. The crimped hollow fibers may be formed from any hollow polymer fiber that is capable of being crimped and is reactive to heat. Pressure, such as from two opposed mating crimping dies, is applied to portions of a hollow polymer fiber to compress or crimp portions of the fiber, thereby leaving uncrimped or expandable regions containing an expandable substance. In use, the crimped hollow fibers may be contacted with cellulose fibers in the wet-end section of the paper-making process and the resulting mixture formed into a web of entangled fibers. Heat from the dryer section expands the expandable substance in the expandable portion of the crimped hollow fiber to bulk the thus formed paper product. The crimped hollow fibers are especially useful in papers having a basis weight from about 20 to about 200 gsm.

### TECHNICAL FIELD AND INDUSTRIAL APPLICABILITY OF THE INVENTION

The present invention relates generally to the papermaking arts, and more particularly, to the use of thermally expandable crimped hollow fibers to enhance the bulk of lightweight papers. A paper substrate including the expandable crimped hollow fibers is also provided.

### BACKGROUND OF THE INVENTION

The amount of cellulose fibers present in a paper substrate, in part, determines the density of the paper. However, cellulose fibers tend to be expensive to produce. As a result, utilizing large amounts of cellulose fibers in a paper substrate produces a denser substrate at a higher cost. Conversely, utilizing low amounts of cellulose fibers in a paper substrate produces a less dense paper substrate at a lower cost. It follows that reducing the density of a paper product leads to reduced production costs of the paper product.

One example of reducing density in a paper substrate includes the use of expandable microspheres. These methodologies can be found, for example, in the following U.S. Pat. Nos. 6,846,529; 6,802,938; 5,856,389; and 5,342,649 and in the following U.S. Patent Publications: 2008/0017338; 2007/0044929; 2007/0208093; 2006/0000569; 2006/0102307; 2004/0065424; 2004/0052989; 2004/0249005 and 2001/0038893. The contents of each of these patents and publications are hereby expressly incorporated by reference in their entirety. In general, expandable microspheres are incorporated into the paper to replace a portion of the cellulose fibers forming the paper product. Upon heating, the gas or blowing agent within the microspheres expands, thereby increasing the overall size of the microsphere and the bulk of the paper.

Although expandable microspheres work well in heavier weight papers such as papers used to form file folders and paper cups, they do not work well in lightweight papers (e.g., copy paper or printer paper). Microspheres, when applied to the papermaking process of such lightweight papers, have low retention in the resultant paper substrate. For instance, the expandable microspheres come out of the paper making machine and fly into the air, contaminating both the paper and the machine. As a result of this contamination, the papermaking machine must be stopped and cleaned, thereby reducing productivity and increasing manufacturing costs. Low density paper substrates are highly desirable from an aesthetic and economic perspective. However, low density, high bulk lightweight paper simply cannot be obtained with the use of conventional expandable microspheres.

Thus, there remains a need in the art for a less costly and more efficient solution to reduce density and increase bulk in lightweight paper while maintaining good performance characteristics such as smoothness and print mottle in the paper substrate.

### SUMMARY OF THE INVENTION

It is an object of the present invention to provide a thermally expandable crimped hollow fiber that is formed of expandable regions interconnected with crimped portions. The crimped portions are incapable of passing air or other expandable substances from one expandable region to another. Additionally, the expandable portions may have varying sizes and shapes with respect to each other and contain an expandable substance such as air or other suitable blowing agent. The crimped hollow fiber has a length that is sufficient to entangle or enmesh with cellulose fibers during the formation of a paper product. The mechanical entanglement of the crimped hollow fibers with the cellulose fibers reduces or even eliminates the possibility of the crimped hollow fibers escaping the paper product and undesirably releasing the crimped hollow fibers into the air. The expandable substance(s) located within the expandable portions of the crimped hollow fiber expand upon the application of heat to provide internal pressure on the polymer forming the crimped fiber to force the expandable portions of the crimped fiber to expand. This expansion of the crimped portion successfully increases the bulk of the paper. The thermally expandable crimped hollow fibers are especially useful in papers having a basis weight from about 20 to about 200 gsm.

It is also an object of the present invention to provide a hollow fiber that includes (1) at least one thermally expandable portion containing therein an expandable substance and (2) a crimped portion positioned on opposing sides of the thermally expandable portion to retain the expandable substance within the thermally expandable portion. The hollow fiber may be used to enhance the bulk of a paper substrate, in particular, a lightweight paper substrate. The expandable substance may be air, nitrogen, argon, carbon dioxide, or any suitable blowing agent. The hollow fiber may be formed from a thermoplastic or thermoset polymer fiber, a biodegradable polymer fiber, a bicomponent fiber, or a multicomponent fiber.

It is another object of the present invention to provide a method of making a thermally expandable crimped hollow fiber that includes applying pressure to portions of a hollow polymer fiber so as to form crimped portions interconnecting expandable portions having therein an expandable substance. The crimped portions are incapable of passing the substance between the expandable portions. The expandable substance located within the expandable regions expands upon the application of heat to force the expandable portions of the crimped fiber to enlarge and increase the bulk of the paper product in which the crimped hollow fiber is contained.

It is yet another object of the present invention to provide a method of making a thermally expandable crimped hollow fiber that includes (1) placing a hollow polymer fiber between two opposing crimping dies, each of the crimping dies having thereon a plurality of spaced apart crimping members and interstitial spaces between adjacent crimping members and (2) mating opposed crimping members to compress regions of the hollow polymer fiber positioned between the crimping members to form crimped portions between the crimping members and expandable portions in the interstitial spaces located between the crimping members. The expandable portions contain a least one expandable substance that expands upon the application of heat. In at least one embodiment, the crimping dies are heated to at least partially melt and fuse the inner portions of the hollow fibers together when forming the crimped portions. The crimping dies may have a substantially planar configuration where the hollow fiber is crimped and then indexed an appropriate distance so as to place an uncrimped portion of the fiber between the crimping dies. Alternatively, the crimping dies may have a circular configuration to provide for a continuous crimping operation. In either embodiment, the crimped hollow fiber may be rolled for storage or cut into desired lengths.

It is a further object of the present invention to provide a paper that includes cellulose fibers and the thermally expandable crimped hollow fibers described above.

It is also an object of the present invention to provide a composition that includes the thermally expandable crimped hollow fibers described above and a plurality of cellulose fibers.

It is another object of the present invention to provide a method of making a paper substrate that includes contacting a plurality of cellulose fibers with at least one thermally expandable crimped hollow fiber described above prior to or at a machine chest, a thin stock, a thick stock, a head box, a size press, or a coater.

It is a further object of the present invention to provide a method of enhancing the bulk of a lightweight paper substrate that includes contacting a plurality of cellulose fibers with at least one thermally expandable crimped hollow fiber described above prior to or at a machine chest, a thin stock, a thick stock, a head box, a size press, or a coater.

It is an advantage of the present invention that the crimped hollow fibers successfully increase the bulk of lightweight papers without contaminating either the paper or the papermaking machine.

It is another advantage of the present invention that the amount of bulking may be varied by the amount of crimped hollow fibers added to the paper making furnish and/or the length and/or denier of the fibers and/or the length of crimped and uncrimped portions on the fibers.

It is yet another advantage of the present invention that the inclusion of the crimped hollow fibers in the paper product reduces the overall cost of the paper product.

It is a further advantage of the present invention that the crimped hollow fibers are easily retained in the paper due, at least in part, to the mechanical entanglement of the crimped hollow fibers with the cellulose fibers within the paper.

It is also an advantage of the present invention that the crimped hollow fibers may enhance the tear strength of the paper.

It is a feature of the present invention that the crimped hollow fibers can be formed from hollow polymer fibers, hollow biodegradable fibers, and/or hollow multicomponent fibers.

It is another feature of the present invention that the expandable portions of the thermally expandable crimped hollow fibers contain at least one blowing agent or other expandable gas.

It is a further feature of the present invention that a hollow polymer fiber can be mechanically crimped to form expandable portions and crimped portions.

It is also a feature of the present invention that the crimped hollow fibers are permanently crimped and do not recover upon the application of external forces.

It is yet another feature of the present invention that the paper substrate containing the thermally expandable crimped hollow fibers demonstrates good performance characteristics such as smoothness and print mottle.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a thermally expandable crimped hollow fiber according to at least one exemplary embodiment of the present invention;

FIG. 1A is a schematic illustration of a thermally expandable crimped hollow fiber having a single expandable portion with crimped portions on opposing sides thereof;

FIG. 2 is a schematic illustration of a crimping apparatus having two opposing crimping dies positioned in an open configuration with a hollow fiber positioned therebetween;

FIG. 3 is a schematic illustration of the crimping apparatus of FIG. 2 in a closed configuration whereby selected portions of the hollow fiber are crimped;

FIG. 4 is a schematic illustration of the crimping apparatus of FIG. 2 in the open configuration after crimping with a thermally expandable crimped hollow fiber positioned between the opposing crimping dies;

FIG. 5 is a schematic illustration of a crimping process utilizing the crimping apparatus depicted in FIG. 2; and

FIG. 6 is a schematic illustration of an alternate crimping apparatus containing two opposing circular crimping dies to selectively crimp portions of the hollow fiber to form a thermally expandable hollow fiber according to at least one embodiment of the invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It will be understood that when an element such as a layer or region, is referred to as being “on” another element, it can be directly on the other element or intervening elements may also be present. Also, when an element is referred to as being “adjacent” to another element, the element may be directly adjacent to the other element or intervening elements may be present. The terms “top”, “bottom”, “side”, and the like are used herein for the purpose of explanation only. Like numbers found throughout the figures denote like elements. As used herein, the terms “paper, “paper substrate”, and “substrate” may be interchangeably used. It is to be appreciated that “thermally expandable crimped hollow fiber”, “expandable crimped hollow fiber”, “crimped hollow fiber”, and “crimped fiber” may be used interchangeably herein. Additionally, the terms “expandable portion” and “expandable region” may be used interchangeably within this application. Similarly, the terms “crimped portion” and “crimped region” may be interchangeably used.

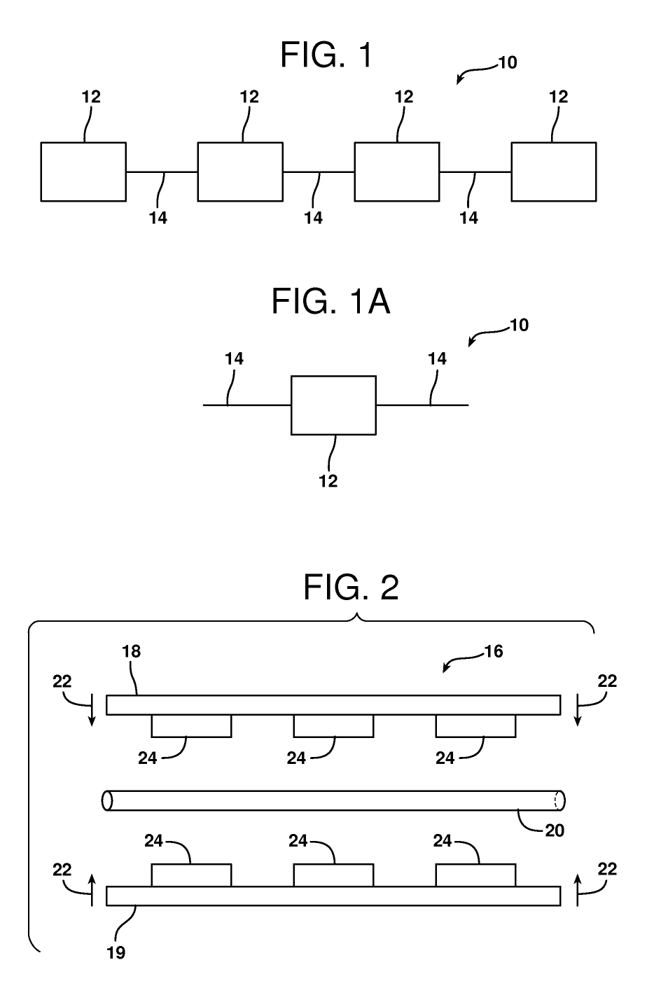

The present invention is directed to the use of thermally expandable crimped hollow fibers to increase the bulk of lightweight papers. As used herein, the term “lightweight papers” is meant to denote papers having a basis weight from about 20 to about 200 gsm, and more particularly, to papers having a basis weight from about 50 to about 120 gsm. A thermally expandable crimped hollow fiber according to the invention is set forth in FIG. 1. As depicted in FIG. 1, the expandable crimped hollow fiber 10 has a series of expandable portions 12 interconnected with crimped portions 14. In its most simplistic form shown in FIG. 1A, the crimped hollow fiber 10 may be formed of a single expandable region 12 with crimped portions 14 on either side thereof. It is to be appreciated that the expandable regions 12 may be of the same or similar size and shape or may have varying sizes and shapes with respect to each other. In addition, the crimped portions 14 are incapable of passing air or other liquid or gaseous substances from one expandable portion 12 to another. The crimped hollow fiber 10 may have any suitable length, but in exemplary embodiments, the crimped expandable fiber 10 has a length from about 0.5 mm to about 6.0 mm, preferably from about 1.0 mm to about 3.0 mm. It is to be understood that all ranges recited herein are intended to include all sub-ranges within the broad range. In one or more exemplary embodiment, the crimped portions 14 account for about 0.1% to about 99.9% of the crimped hollow fiber 10, preferably from about 50% to about 75%, and the expandable portions 14 account for about 99.9% to about 0.1% of the crimped hollow fiber 10, preferably from about 50% to about 25%.

The crimped hollow fiber 10 may be formed from any hollow thermoplastic or thermoset polymer material that is capable of being crimped and is reactive to heat. Non-limiting examples of suitable polymers include polypropylene, polyethylene, polyester, polyamide, polyimide, polyvinyl alcohol, ethylene vinyl alcohol, polyacrylates, polycaprolactam, vinylidene chloride, and copolymers and mixtures thereof. The polymer material may also or alternatively be a hollow biodegradable polymer such as, but not limited to, poly(lactic acids) (PLAs), poly(glycolic acid), polycaprolactone, polybutylene succinate, and polyhydroxyalcanoates (PHAs) including polyhydroxybutyrate or polyhydroxybutyrate-polyhydroxyvalerate copolymers. The perimeter of the inner region (i.e., hollow portion) of the hollow fiber may be concentric or substantially non-concentric to the perimeter of the outer region (i.e., polymer portion) of the hollow fiber. Further, the crimped hollow fiber 10 may be monoconstituent or multiconstituent and may be smooth or texturized.

In addition, the crimped fiber 10 may be formed from a bicomponent or other multicomponent fiber. The bicomponent fibers may be arranged in a sheath-core, side-by-side, islands-in-the-sea, or segmented-pie arrangement. In at least one exemplary embodiment, the bicomponent fibers are formed in a sheath-core arrangement in which the sheath is formed of first polymer fibers that substantially surrounds the core formed of second polymer fibers. It is not required that the sheath fibers totally surround the core fibers. The first polymer fibers have a melting point lower than the melting point of the second polymer fibers so that upon heating the bicomponent fibers, the first and second polymer fibers react differently. For example, when the bicomponent fibers are heated to a temperature that is above the melting point of the first polymer fibers (sheath fibers) and below the melting point of the second polymer fibers (core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity, such as in the drying section of the papermaking process. Numerous combinations of materials can be used to make the bicomponent polymer fibers, such as, but not limited to, combinations using polyester, polypropylene, polysulfide, polyolefin, and polyethylene fibers.

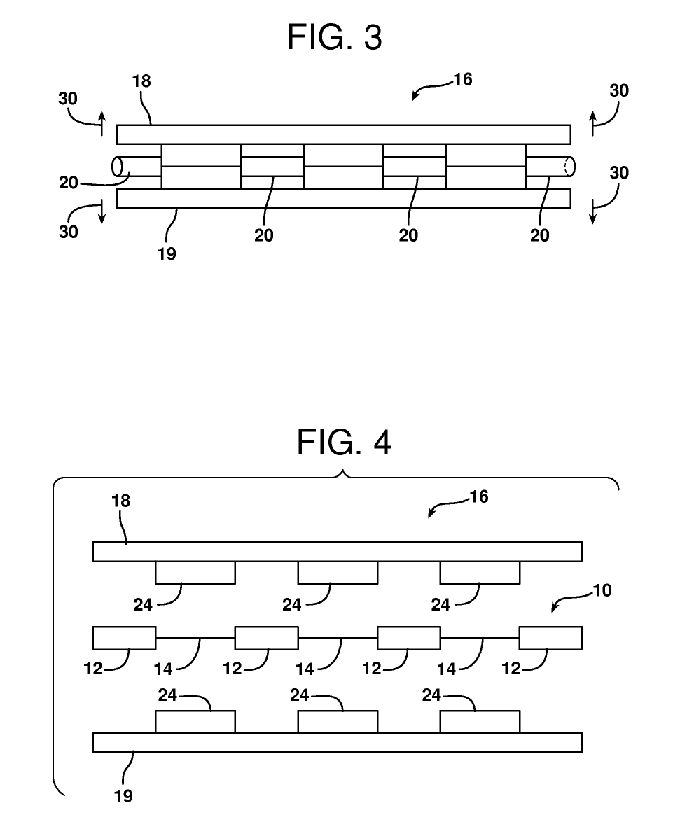

The crimped hollow fibers 10 may be made by any suitable process that crimps or otherwise compresses portions of a hollow fiber so as to form uncompressed, expandable regions 12 interspaced by the crimped portions 14. One such method is illustrated schematically in FIGS. 2-4. A crimping apparatus 16, as shown generally in FIG. 2, may be formed of two opposing crimping dies 18, 19 having corresponding crimping members 24 that are movable toward one another to crimp the hollow fiber 20 therebetween. In particular, each of the crimping ides 18, 19 have thereon a plurality of spaced apart crimping members 24 and interstitial spaces between adjacent crimping members 24. To form a crimped fiber 10, a hollow polymer fiber as described in detail above is positioned between opposing crimping dies 18, 19 when the dies are in an open configuration. The crimping dies 18, 19 are then moved in a direction toward each other as indicated by arrows 22 until the dies 18, 19 are in a closed configuration as illustrated in FIG. 3. In the closed configuration, the crimping members 24 of the dies 18, 19 mate against each other so as to compress the regions of the fiber 20 located between the crimping members 24, thereby forming crimped portions 14 between the mated crimping members 24 and expandable portions 12 within the interstitial spaces. In some embodiments, the crimping members 24 and/or crimping dies 18, 19 may be heated to at least partially melt and fuse the inner portions of the fiber 20 together. After the hollow fiber 20 has been crimped to form the crimped fiber 10, the dies 18, 19 are opened in the direction of arrows 30 to again place the crimping apparatus 16 in an open configuration as shown in FIG. 4.

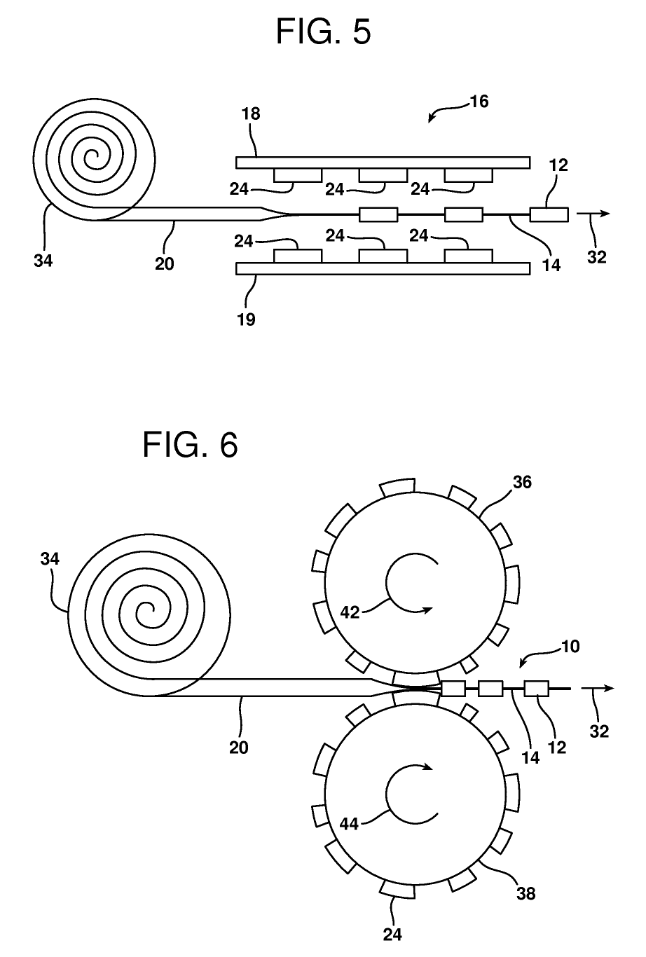

While a single hollow fiber 20 is shown in FIGS. 2-4, one of skill in the art would desirably utilize a continuous hollow fiber 20 that that may be incrementally moved through the crimping apparatus 16 to sequentially crimp portions of the hollow fiber 20. The continuous hollow fiber may be a pre-formed fiber pulled from a roll 34 as shown in FIG. 5 or it may be a hollow fiber obtained directly in an in-line process (not illustrated). Thus, in one embodiment, the hollow fiber 20 may be indexed an appropriate distance in the direction of arrow 32 so as to place an uncrimped portion of the fiber 20 between the crimping dies 18, 19. The crimping process depicted in FIGS. 2 and 3 may then be repeated to form another crimped portion of the fiber 20. The thus formed crimped fiber (e.g., continuous crimped fiber) may be rolled for storage or cut into desired lengths. It is believed that if the hollow fiber 20 is obtained directly after forming, the residual heat may be sufficient to fuse the crimped portions 14 when the crimping apparatus 16 is in the closed configuration. It is to be appreciated that any means or method that applies suitable pressure to the hollow fiber 20 to crimp or compress portions of the fiber 20 to form crimped regions 14 and expandable regions 12 on the fiber may alternatively be used to form the crimped hollow fiber 10.

An alternate embodiment is schematically depicted in FIG. 6. In this embodiment, circular crimping dies 36, 38 provide for a continuous crimping operation. As with the embodiment depicted in FIGS. 2-5, crimping dies 36, 38 each have thereon a plurality of spaced apart crimping members 24 and interstitial spaces between adjacent crimping members 24. A continuous hollow fiber 20 is positioned between the circular crimping dies 36, 38. As the hollow fiber moves in the direction of arrow 32, the circular dies 36, 38 turn in opposing directions shown by arrows 42, 44 so as to continuously crimp the hollow fiber 20 and form a crimped hollow fiber 10. More specifically, as the circular crimping dies 36, 38 move in the direction of arrows 42, 44, the crimping members 24 of the dies 36, 38 mate against each other to compress the regions of the fiber 20 positioned therebetween to form crimped portions 14 between the mated crimping members 24 and expandable portions 12 in the interstitial spaces. As with the embodiment depicted in FIG. 5, the hollow fiber may be obtained directly from a fiber forming device in an in-line process (not illustrated). In the exemplary embodiments depicted herein, the fiber is crimped in a permanent fashion and does not un-crimp upon the application of an external force, such as, for example, heat or water.

While the crimped hollow fibers of the present invention may have any use, an exemplary use is in conventional papermaking processes to make paper. The paper includes a web of cellulose fibers and the above-described thermally expandable crimped hollow fibers. The paper may be produced as a single layer or a multi-layer paper having two or more layers. Additionally, the paper may or may not be calendared. Paper according to the present invention may contain from 1 to 99 wt % and desirably from 5 to 95 wt % of cellulose fibers based upon the total weight of the paper.

The amount of thermally expandable crimped hollow fibers present in the paper depends upon the total weight of the substrate and/or the final paper product. The paper substrate may contain greater than 0.001 wt %, more preferably greater than 0.02 wt %, and most preferably greater than 0.1 wt % of the crimped hollow fibers based on the total weight of the substrate. Further, the paper substrate may contain less than 20 wt %, preferably less than 10 wt %, and more preferably less than 5 wt % of the crimped hollow fibers based on the total weight of the substrate.

The paper is provided as a web containing cellulosic pulp fibers such as fibers derived from hardwood trees, softwood trees, or a combination of hardwood and softwood trees. The fibers may be prepared for use in a papermaking furnish by any known suitable digestion, refining, and bleaching operations. The paper may optionally contain recycled fibers and/or virgin fibers. It is to be appreciated that recycled fibers differ from virgin fibers in that the recycled fibers have gone through a drying process at least once. In certain embodiments, at least a portion of the fibers may be provided from non-woody herbaceous plants including, but not limited to, kenaf, hemp, jute, flax, sisal, or abaca, although legal restrictions and other considerations may make the utilization of hemp and other fiber sources impractical or even impossible. Additionally, the paper may include conventional additives such as, for example, starch, mineral fillers, sizing agents, retention aids, and strengthening polymers. Among the fillers that may be used are organic and inorganic pigments such as, for example, polymeric particles such as polystyrene latexes and polymethylmethacrylate, and minerals such as calcium carbonate, kaolin, and talc.

Additionally, the softwood and/or hardwood fibers forming the web may be physically and/or chemically modified. Examples of physical modification include, but are not limited to, electromagnetic and mechanical modification. One non-limiting example of electrical modification includes methods involving contacting the fibers with an electromagnetic energy source such as light and/or an electrical current. Suitable methods for mechanical modification of the fibers include methods that involve contacting an inanimate object with the fibers. Examples of such inanimate objects include objects having sharp and/or dull edges. Mechanical methods may also involve, for example, cutting, kneading, pounding, and/or impaling the fibers.

Examples of chemical modification methods include conventional chemical fiber modification methods such as crosslinking and precipitation of complexes thereon. Non-limiting examples of such chemical modification of fibers may include those found in the following U.S. Pat. Nos. 6,592,717; 6,592,712; 6,582,557; 6,579,415; 6,579,414; 6,506,282; 6,471,824; 6,361,651; 6,146,494; 141,704; 5,731,080; 5,698,688; 5,698,074; 5,667,637; 5,662,773; 5,531,728; 5,443,899; 5,360,420; 5,266,250; 5,209,953; 5,160,789; 5,049,235; 4,986,882; 4,496,427; 4,431,481; 4,174,417; 4,166,894; 4,075,136; and 4,022,965, each of which is expressly incorporated by reference in its entirety.

In exemplary embodiments, the source of the cellulosic pulp fibers is from softwood and/or hardwood trees. The cellulosic fibers in the paper may include from about 0% to about 100% or from about 20% to about 80% by weight dry basis softwood fibers and from about 0% to about 100% or from about 20% to about 80% by weight dry basis hardwood fibers.

The method of forming a paper according of the present invention includes first providing an initial paper furnish including cellulose fibers and thermally expandable crimped hollow fibers. The thermally expandable crimped hollow fibers may be added to the paper furnish in an amount sufficient to achieve from about 1.0% to about 20% by weight in the final paper product. In preferred embodiments, the expandable crimped hollow fibers may be added in an amount to achieve from about 2.0% to about 12.0% by weight in the final paper product, and even more desirably from about 5.0% to about 8.0% by weight.

The expandable crimped hollow fibers may be contacted with the cellulose fibers consecutively and/or simultaneously. Still further, the contacting may occur at acceptable concentration levels that enable the paper substrate to contain any of the above-mentioned amounts of cellulose and thermally expandable crimped hollow fibers. It is to be appreciated that the contacting of the crimped hollow fibers may occur anytime during the papermaking process including, but not limited to, the thick stock, thin stock, head box, coater, size press, and stuff box, with the preferred addition point being at the machine chest. In addition, the paper may be made by contacting further optional substances with the cellulose fibers as well. This contacting of optional substances may also occur anytime in the papermaking process including, but not limited to the thick stock, thin stock, head box, size press, water box, and coater. Further addition points for these optional substances include the machine chest, stuff box, and suction of the fan pump. The cellulose fibers, crimped hollow fibers, and/or optional components may be contacted serially, consecutively, and/or simultaneously and in any combination with each other. In addition, the cellulose fibers and crimped hollow fibers may be pre-mixed in any combination before addition to or during the paper-making process.

The cellulosic fibers may be in the form of chemically pulped fibers, such as bleached kraft pulp or sulfite pulps, mechanically treated pulps such as ground wood pulps, and/or other pulp varieties and mixtures thereof, such as chemical-mechanical and thermo-mechanical pulps. In one or more exemplary embodiment, the pulp may be bleached to remove lignins and to achieve a desired pulp brightness according to one or more bleaching treatments known in the art, such as, for example, elemental chlorine-based bleaching sequences, chlorine dioxide-based bleaching sequences, chlorine-free bleaching sequences, elemental chlorine-free bleaching sequences, and combinations or variations of stages of any of the foregoing and other bleaching related sequences and stages.

After bleaching is completed and the pulp is washed and screened, the pulp may be subjected to one or more refining steps. Thereafter, the refined pulp is passed to a blend chest where it is mixed with various additives and fillers typically incorporated into a papermaking furnish, as well as other pulps such as unbleached pulps and/or recycled or post-consumer pulps. The additives may include “internal sizing” agents that are used primarily to increase the contact angle of polar liquids contacting the surface of the paper. Non-limiting examples of these “internal sizing” agents include alkenyl succinic anhydride (ASA), alkyl ketene dimer (AKD), and rosin sizes. In addition, retention aids, including cationic and/or anionic retention aids, may be added at this stage.

Once prepared, the furnish is formed into a single or multi-ply web on a papermaking machine, such as a Fourdrinier machine or any other suitable papermaking machine. The basic methodologies involved in making paper on various papermaking machine configurations are well-known to those of ordinary skill in the art and accordingly, such methods will not be described in detail herein. In general, a furnish consisting of a relatively low consistency aqueous slurry of the pulp fibers (typically about 0.1 to about 1.0%) along with various additives and fillers dispersed therein is ejected from a headbox onto a porous, endless moving forming sheet or wire where the liquid is gradually drained through small openings in the wire until a mat of pulp fibers and the other materials in the furnish is formed on the wire. The still-wet mat or web is then transferred from the wire to a wet press where more fiber-to-fiber consolidation occurs and the moisture is further reduced.

The web is then passed to an initial dryer section to remove most of the retained moisture and further consolidate the fibers in the web. Any drying means commonly known in the art of papermaking may be utilized. The drying section may include a drying can, cylinder drying, Condebelt drying, IR, or other drying means and mechanisms known in the art. The paper substrate may be dried so as to contain any selected amount of water. However, the substrate is preferably dried to contain less than or equal to 10% water.

In the dryer section, the expandable substance (e.g., air) present within the expandable regions of the thermally expandable crimped hollow fibers shown in FIG. 1 (and/or FIG. 1A) expands due to the heat in the dryer section. This expansion of the expandable regions of the crimped hollow fibers increases the bulk of the paper. Also, because the expandable crimped hollow fibers are added at the wet end of the papermaking process, the crimped hollow fibers become entangled with the cellulose fibers. Unlike conventional expandable microspheres, the crimped hollow fibers have a length which assists in mechanically entangling the crimped hollow fibers with the cellulose fibers. The mechanical entanglement of the expandable crimped hollow fibers and cellulose fibers reduces or even prevents the crimped hollow fibers from escaping the paper and/or papermaking machine and releasing the crimped fibers into the air. By retaining the crimped hollow fibers in the paper, there is little to no contamination of the paper or the papermaking machine and the paper is effectively bulked. The amount of bulking may be varied by the amount of thermally expandable crimped hollow fibers added to the paper making furnish and/or the length and/or denier of the fibers and/or the length of crimped and uncrimped portions on the fibers.

It is envisioned that the hollow fibers, and thus the expandable regions formed within the thermally expandable crimped hollow fibers, can contain a blowing agent or other suitable expandable substance. The blowing agent located within the expandable regions would not be particularly limited, and may be any blowing agent that, upon the application of heat energy, functions to provide internal pressure on the polymer forming the crimped fiber to force the expandable regions of the crimped hollow fiber to expand. The blowing agent may be liquid and/or gas. Non-limiting examples of suitable blowing agents for use in the crimped hollow fiber include low boiling point hydrocarbons (e g, propane, n-pentane, isopentane, neopentane, hexane, neohexane, butane, isoheptane, octane, and isooctane), chlorinated hydrocarbons or fluorinated hydrocarbons (e.g., methyl chloride, methylene chloride, dichloroethane, trichloroethane, and perfluorinated hydrocarbons), and/or inert gases (e.g., air, nitrogen, argon, helium, and carbon dioxide). One or more blowing agent may be present within the expandable regions of the crimped hollow fiber. It is to be appreciated that the blowing agent is not a conventional blowing agent in the sense that it is a hydro-fluorocarbon (HFC) or a hydro-chloro-fluorocarbon (HCFC) blowing agent.

After the web has been initially dried, it may be treated with a sizing agent such as a binder at a size press. Any sizing means commonly known in the art of papermaking is acceptable. The size press utilized to apply the coating composition is not particularly limited, and includes size presses such as, but not limited to, a rod size press and a puddle size press. Optionally, the sizing agents may be added at the wet end of the papermaking process as needed.

Next, the paper may be calendared to achieve the desired final caliper and to improve the smoothness and other properties of the web. The calendaring may be accomplished by steel-steel calendaring at nip pressures sufficient to provide a desired caliper. It will be appreciated that the ultimate caliper of the paper will be largely determined by the selection of the nip pressure.

Although the use of the expandable crimped hollow fiber has been described herein with respect to lightweight paper, the thermally expandable crimped hollow fiber of the present invention may be utilized in any and all end uses commonly known in the art for using paper and/or paperboard substrates. Such end uses include the production of paper and/or paperboard packaging and/or articles, including those requiring high and low basis weights in the respective substrates, which can range from envelopes and forms to folding cartons, respectively. Further, the end product may have multiple paper substrate layers, such as corrugated structures, where at least one layer contains the expandable crimped hollow fiber of the present invention. Additionally, the expandable crimped hollow fibers may be included in other materials, such as polymers, metals, clothing, and insulation products, where heat, or other suitable energy, may be applied to the crimped hollow fibers to create bulk.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A hollow fiber for enhancing the bulk of a paper substrate comprising:
at least one thermally expandable portion containing therein at least one expandable substance; and
a crimped portion positioned on opposing sides of said thermally expandable portion to retain said expandable substance within said thermally expandable portion.

2. The hollow fiber of claim 1, wherein said at least one thermally expandable portion comprises a plurality of said thermally expandable portions with one of said crimped portions interconnecting adjacent said thermally expandable portions.

3. The hollow fiber of claim 1, wherein said expandable substance is selected from the group consisting of low boiling point hydrocarbons, chlorinated hydrocarbons, fluorinated hydrocarbons, air, nitrogen, argon, carbon dioxide and mixtures thereof.

4. The hollow fiber of claim 3, wherein said expandable substance is a gaseous substance selected from the group consisting of air, nitrogen, argon, carbon dioxide and mixtures thereof.

5. The hollow fiber of claim 1, wherein said hollow fiber is selected from the group consisting of a thermoplastic polymer fiber, a thermoset polymer fiber, a biodegradable polymer fiber, a bicomponent fiber and a multicomponent fiber.

6. A thermally expandable crimped hollow fiber comprising:
a polymer fiber including:
a plurality of expandable portions containing therein at least one expandable substance; and
a plurality of crimped portions interconnecting said expandable portions.

7. The thermally expandable crimped hollow fiber of claim 6, wherein said crimped potions are incapable of passing said at least one expandable substance between said expandable portions.

8. The thermally expandable crimped hollow fiber of claim 6, wherein said polymer is selected from the group consisting of polypropylene, polyethylene, polyester, polyamide, polyimide, polyvinyl alcohol, ethylene vinyl alcohol, polyacrylates, polycaprolactam, vinylidene chloride and copolymers and mixtures thereof.

9. The thermally expandable crimped hollow fiber of claim 6, wherein said polymer fiber is selected from the group consisting of a thermoplastic polymer fiber, a thermoset polymer fiber, a biodegradable polymer fiber, a bicomponent fiber and a multicomponent fiber.

10. The thermally expandable crimped hollow fiber of claim 6, wherein said at least one expandable substance is selected from the group consisting of low boiling point hydrocarbons, chlorinated hydrocarbons, fluorinated hydrocarbons, air, nitrogen, argon, carbon dioxide and mixtures thereof.

11. The thermally expandable crimped hollow fiber of claim 10, wherein said expandable substance is a gaseous substance selected from the group consisting of air, nitrogen, argon, carbon dioxide and mixtures thereof.

12. A method of making a thermally expandable crimped hollow fiber comprising:
applying pressure to portions of a hollow polymer fiber so as to form crimped portions interconnecting expandable portions having therein at least one expandable substance, said crimped potions being incapable of passing said expandable substance between said expandable portions.

13. A method of making a thermally expandable crimped hollow fiber comprising:
placing a hollow polymer fiber between two opposing crimping dies, each said crimping die having thereon a plurality of spaced apart crimping members and interstitial spaces between adjacent crimping members; and
mating opposed said crimping members to compress regions of said hollow polymer fiber positioned between said crimping members to form crimped portions between said crimping members and expandable portions in said interstitial spaces between said crimping members, said expandable portions having therein at least one expandable substance.

14. The method of claim 13, further comprising heating said crimping members to at least partially melt and fuse inner portions of said hollow fiber at said crimped portions.

15. The method of claim 13, wherein said hollow polymer fiber is a continuous hollow polymer fiber and said method further comprises indexing said continuous hollow polymer fiber an appropriate distance and place an uncrimped portion of said continuous hollow fiber between said crimping dies.

16. The method of claim 13, wherein said crimping dies have a circular configuration to provide a continuous crimping operation.

17. The method of claim 16, wherein said hollow polymer fiber is a continuous hollow polymer fiber and said method further comprises continuously moving said continuous hollow fiber through said crimping dies to sequentially crimp portions of said continuous hollow fiber.

18. The method of claim 13, further comprising forming said hollow polymer fiber prior to placing said hollow polymer fiber between said crimping dies.

19. A composition comprising the thermally expandable crimped hollow fiber of claim 6 and a plurality of cellulose fibers.

20. A paper comprising:
a web including a plurality of cellulose fibers and a plurality of thermally expandable crimped hollow fibers, said thermally expandable crimped hollow fibers comprising:
a polymer fiber including:
a plurality of expandable portions containing therein at least one expandable substance; and
a plurality of crimped portions interconnecting said expandable portions.

21. The paper of claim 20, wherein said paper has a basis weight from about 20 to about 200 gsm.

22. The paper of claim 20, wherein said crimped portions are incapable of passing said at least one expandable substance between said expandable portions.

23. The paper of claim 20, wherein said polymer fiber is selected from the group consisting of a thermoplastic polymer fiber, a thermoset polymer fiber, a biodegradable polymer fiber, a bicomponent fiber and a multicomponent fiber.

24. The paper of claim 20, wherein said polymer is selected from the group consisting of polypropylene, polyethylene, polyester, polyamide, polyimide, polyvinyl alcohol, ethylene vinyl alcohol, polyacrylates, polycaprolactam, vinylidene chloride and copolymers and mixtures thereof.

25. The paper of claim 20, wherein said at least one expandable substance is selected from the group consisting of low boiling point hydrocarbons, chlorinated hydrocarbons, fluorinated hydrocarbons, air, nitrogen, argon, carbon dioxide and mixtures thereof.

26. The paper of claim 25, wherein said expandable substance is a gaseous substance selected from the group consisting of air, nitrogen, argon, carbon dioxide and mixtures thereof.

27. A method of making a paper substrate, comprising
contacting a plurality of cellulose fibers with at least one thermally expandable crimped hollow fiber according to claim 6 prior to or at a machine chest, a thin stock, a thick stock, a head box, a size press, or a coater.

28. A method of enhancing the bulk of a lightweight paper substrate, said method comprising
contacting a plurality of cellulose fibers with at least one thermally expandable crimped hollow fiber according to claim 6 at a prior to or at machine chest, a thin stock, a thick stock, a head box, a size press, or a coater.
